(19) United States
(12) Patent Application Publication
(10) Pub. No.: US 2024/0199301 A1
(43) Pub. Date: Jun. 20, 2024

(54) POLYLACTIC ACID-BASED CUSTOM PRODUCT PACKAGING AND ASSOCIATED METHODS

(71) Applicant: Lifoam Industries, LLC, Greer, SC (US)

(72) Inventors: Saumitra Bhargava, Clarksville, MD (US); Jonathan Godfrey, Joppa, MD (US)

(21) Appl. No.: 18/477,183

(22) Filed: Sep. 28, 2023

Related U.S. Application Data
(60) Provisional application No. 63/476,041, filed on Dec. 19, 2022.

(51) Int. Cl. B65D 81/113; B65D 65/46; B65D 81/02

(52) U.S. Cl. CPC B65D 81/113; B65D 65/44; B65D 65/466; B29C 65/48; B65D 2581/056

(57) ABSTRACT

A method for adhering polylactic acid-based (such as expandable polylactic acid resin (PLA) foam) custom product packaging to a surface is provided. The surface is heated to a suitable temperature and the PLA foam may be pressed against the surface for a second or seconds to rapidly adhere the PLA foam to the surface. The adhesion between the surface and the PLA foam may be sufficient to maintain the adhesion, but may also allow for the PLA foam to be removed from the surface.

### CROSS-REFERENCE TO RELATED APPLICATION

This application claim priority to U.S. Provisional Patent Application No. 63/476,041, filed Dec. 19, 2022, which is incorporated herein by reference.

### FIELD OF THE DISCLOSURE

This disclosure relates generally to molded foam articles and, in particular, relates to custom product packaging composed of low-density molded foam articles formed from polylactic acid and further modified through adhesion to various substrates.

### BACKGROUND

Molded foam articles are used in a variety of diverse industries including thermal insulation and protective packaging, construction, infrastructure support, foodservice, and consumer products. Molded foam articles are commonly produced from expandable polystyrene (EPS), which has a well-known manufacturing process. However, EPS-based foam articles suffer from a variety of drawbacks that prevent not only recycling the EPS article, but also repurposing the EPS article for secondary uses.

Consumer-facing foam articles such as insulated shippers are commonly used for shipping meal kits, confectionary products, cakes, other perishable goods, and pharmaceutical items such as vaccines. These insulated shippers are normally discarded by the end-user after their initial purpose has been served, and discarded EPS products contribute over 1,300 tons of waste to landfills in the United States every day.

Prior attempts to reduce molded bead foam article waste have included a shift towards biobased and compostable foam materials as alternatives to EPS. For example, expandable polylactic acid (PLA or EPLA) can be used to produce molded foam articles having insulative and protective properties equal to or superior to those of EPS, but with the added benefit of being compostable. However, molded foam articles rarely have utility in any secondary use beyond the initial application for which the molded bead foam article was made.

Creating production lines and equipment to produce protective packaging for a unique or a small number of products is wasteful. Protective kits made with polyurethane (PU) with partially cut pieces are available to increase customization of the protective packaging. By cutting or pulling apart the partially cut pieces, the foam can be adapted to the product being shipped. While this may reduce the costs of producing the protective packaging by homogenizing the manufacturing requirements of the kit, the kit creates waste polyurethane foam because of the need to cut or remove pieces to fit the application. Furthermore, the packaging remains ill-defined for the specific product being shipped. One-of-a-kind articles such as musical instruments also need easily customizable protective packaging having a high modulus (compared to flexible PU foam).

Hybrid packaging including foam, corrugate, and tape; foam, tape, and film; or molded pulp, corrugate, and tape are also common. EPS or another foam is often used to cover an article being protected. Once covered, the article may then be placed in corrugate or film. Alternatively, the packaging process may start with a corrugated box and EPS or another foam may be added to the base and sides of the box. However, this may be a difficult process that requires time and often results in failures. The foam either must be held in place or attached to the article being protected with tape or hot melt adhesive. Protecting the goods being shipped is important to end user satisfaction. Not following the process correctly can lead to breakage, complaints, and added expense. Many of the packaging steps are challenging to automate, especially aspects of the process in which tape is used.

Additionally, in conventional product packaging, large volumes of low density foam may be used to provide protection for the product during shipment. Low density foams such as EPS, expanded polypropylene (EPP), polyethylene foam (PE), and PU rapidly fill up a trash receptacle whenever a consumer receives an appliance, furniture, television, fragile goods, windows, shower doors, candles, etc. Not only that, but the foam also occupies more than five times the volume of the product within the shipping container (e.g., box, etc.). When receiving a shower door at home, the packaging around the door includes EPS foam held on the glass shower door with fiber tape. In addition, the entire system may be wrapped in film and then sealed again with fiber tape. This further illustrates the amount of material that may be required to be disposed subsequent to shipment of a product.

Accordingly, improved product packaging is needed for overcoming one or more of the technical challenges described above.

### BRIEF DESCRIPTION OF THE DRAWINGS

The detailed description is set forth with reference to the accompanying drawings. The use of the same reference numerals may indicate similar to identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1A-1C is foam adhered to various types of metals in accordance with an embodiment of the disclosure.

FIG. 2 is foam adhered to a surface with a limited contact cross-section in accordance with an embodiment of the disclosure.

FIGS. 3A-3B is foam adhered to wood in accordance with an embodiment of the disclosure.

FIGS. 4A-4B is foam adhered to glass in accordance with an embodiment of the disclosure.

FIG. 5 is foam adhered to engineered plastic in accordance with an embodiment of the disclosure.

FIG. 6A is foam adhered to marble in accordance with an embodiment of the disclosure.

FIG. 6B is foam adhered to brick in accordance with an embodiment of the disclosure.

### DETAILED DESCRIPTION

Custom product packaging is provided herein including custom product packaging composed of one or more molded bead foam articles that have been modified through adhesion to one or more of a variety of substrates. In particular, it has been unexpectedly discovered that forming the one or more molded bead foam articles from polylactic acid enables the molded bead foam article to be adhered to substrates in ways superior to or, in some cases, impossible in a comparable EPS molded foam article.

Throughout this disclosure, various aspects are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

As used herein, the term “about” with reference to dimensions refers to the dimension plus or minus 10%.

### Overview of Adhesion Process

It was unexpectedly discovered that when a surface is rapidly heated to between (and inclusive of) 250 to 450° F. and a piece of polylactic acid resin (PLA) foam is pressed on the heated surface of an object, adhesion occurs between the PLA molded foam and the heated surface within a second to 5 seconds. The heating process of the surface is rapid enough that the bulk of the object remains at a room temperature (for example a human operator may be able to hold one portion of the object while heating another portion of the object to which the PLA foam is adhered). In this manner, a PLA molded foam may be quickly adhered to any type of surface by heating the surface and pressing the PLA molded foam against the surface. This process may be performed without requiring an additional adhesive to provide between the foam and the object to which the foam is being adhered. The adhesion force may be sufficiently strong that the PLA molded foam may remain adhered to the surface, however, the PLA molded foam may be removable from the surface if sufficient force is applied to pull the PLA molded foam from the surface. After removal, the surface of the PLA is free from debris and has the same appearance as the bulk, unmodified or unadhered surface of PLA after simply wiping the surface.

### Custom Product Packaging

Custom product packaging is disclosed herein. In some embodiments, the custom product packaging includes at least one molded bead foam article comprising expandable polylactic acid (PLA or PLA). In some embodiments, the at least one molded bead foam article may comprise PLA foam. As used herein, a “molded bead foam article” refers to an article formed from a polymeric bead foam that has gone through an expansion and bead molding process, such as a PLA molded foam. Thus, reference herein to “at least one molded beam foam article” (or like terms) may similarly refer to a PLA molded foam. The article may be in the form of a two-dimensional panel or a three-dimensional structure such as a box.

In some embodiments, the at least one molded bead foam is adhered to a surface by heating the surface and pressing the at least one molded bead foam article against the surface. It has unexpectedly been discovered that PLA foam rapidly adheres to heated metal leading to a strong bond between, for example, aluminum foil and PLA foam. It was also unexpectedly discovered that this approach of heating a material and rapidly adhering the PLA foam to the material may be used to adhere PLA foam to surfaces of other types of materials as well, such as glass, wood, engineered plastics, other metals, fabrics, leather, vinyl, etc. In some embodiments, the surface comprises at least one of: metal, engineered plastic, glass, wood, brick, stone, ceramic, concrete, fabric, leather, or vinyl. In some embodiments, the surface comprises a substrate having a thickness of 0.1 mm or more. This approach may also be applied to any other type of material described herein and even materials not described herein. That is, the process described herein may allow for the rapid adhesion of a PLA molded foam to a vast array of different types of materials. The adhesion approach described herein may also be automated.

A consequence of the ability to form a strong bond with such a variety of materials is the ability for PLA foam to join two different surfaces which are otherwise challenging to join, such as glass to brick, glass to concrete, leather to brick, or any other combination of the materials described herein.

In some embodiments, the at least one molded bead foam article is pressed against the surface for less than a second. In some instances, the at least one molded bead foam article may be pressed against the surface for less than a few seconds (for example, less than five seconds). That is, in some instances, “rapid” adhesion may refer to adhesion that occurs between the PLA foam and the surface to which the PLA foam is being adhered in less than a second or seconds (however, this is merely exemplary). In this manner, the surface may only need to be heated for a short period of time to perform the adhesion.

In some embodiments, the at least one molded bead foam article is removable from the surface. That is, the at least one molded bead foam article may be rapidly adhered to any type of surface for use in various use cases as described herein or otherwise, while allowing for the foam to be removed from the surface when the foam is no longer required. As a non-limiting example, after shipment of a product has been completed, the foam may be removed from the product for disposal. For example, pressing the PLA molded foam against the surface while the surface is heated may result in the PLA molded foam article being adhered to the surface with a bond equivalent to approximately 2-200 pound force peel strength. That is, adhesion process described herein achieves a bond that is sufficiently strong to survive the shipment process, while also being sufficiently weak to allow for the PLA molded foam to be removed from materials such as metal, wood, engineered plastics, paper, concrete block, brick, stone slabs, ceramic, glass, fabric, leather, vinyl, etc. In this manner, the packaging may also be recycled or composted.

For example, one or more pieces of PLA foam may be adhered directly to an appliance, such as a refrigerator, to protect the various sides of the refrigerator during shipment without needing to secure the protection with tape, plastic wrap, or another securing means. As another example, PLA foam may be adhered directly to multi-material articles, such as a slow cooker which may include some combination of metal, plastic, and glass, or a piece of furniture which may include some combination of wood, glass, fabric, leather, vinyl, etc.

The adhesion process described herein also allows for the PLA molded foam to be removed from the material to which it is adhered without residue being left on the surface of the material, unlike conventional packaging materials, such as tape or other adhesives. Thus, when shipping appliances such as refrigerators, slow cookers, and the like, the foam is easily removed from the surface of the appliance by the consumer. The adhesion to brick, stone slabs, ceramic, and concrete may be beneficial as this allows for use cases beyond product packaging.

In some embodiments, heating the surface is performed using a heating element, wherein the heating element comprises a heated roller, a heated platen, a hot air gun, an infrared-emitting device, a conduction heater, an induction spot heater, steam, or heated fluids. Any of these heating elements may be used to heat a surface of a material such that the PLA foam may be pressed against the surface to adhere the PLA foam to the surface. In some embodiments, the surface is heated to a temperature between (and inclusive of) 250° F. and 450° F., for example. Heating the surface to such a temperature may allow for the rapid adhesion of the PLA foam to the surface. These are merely examples of types of heating elements and any other type of element capable of heating a surface may also be used. These heaters can be operated with electricity, steam, thermal transfer fluids, kerosene, heating oil, solar, natural gas, for example.

In some embodiments, only a portion of surface is heated to adhere the at least one molded bead foam article to the surface. That is, not all of the surface of the material to which the PLA foam is to be adhered needs to be heated to adhere the PLA foam to the surface. For example, when testing this adhesion process using metal coupons, one end of a 6″ metal coupon was rapidly heated while holding the other side with a bare hand. During this test, the surface at the tip was hot enough for PLA foam adhesion without the holding edge increasing noticeably in temperature.

In some embodiments, a size of the portion of the surface is less than a surface area of a portion of the at least one molded bead foam article that is adhered to the surface. That is, the total adhesion force between the PLA molded foam and the surface may be modified (for example, to modify the amount of force required to remove the foam from the surface) by changing the cross-section of the contact surface between the PLA molded foam and the surface to which the PLA molded foam is being adhered. This may be accomplished by limiting the area of the surface of the material that is heating relative to the overall surface area of the surface of the PLA foam that is being adhered to the surface of the other material. For example, if an eight square inch foam is desired to be adhered to metal, only two square inches of the surface of the metal may be heated. This results in a smaller area of adhesion between the PLA molded foam and the metal, and thus a smaller amount of force is required to remove the foam from the metal. This may also be accomplished by creating specialty foam shapes such as ridges and adhering the foam only at the ridge to the metal (or other materials).

In some embodiments, heating the at least one surface of the first molded bead foam article is performed without producing flammable gas. EPS-based molded bead foam articles are formed using a pentane blowing agent. As a result, EPS articles must condition for upwards of a month in a warehouse to permit sufficient pentane to degas to mitigate the possibility that the EPS will be flammable. PLA is produced without flammable blowing agent and thus can be heated immediately upon molding to later with no generation of flammable gas.

In some embodiments, the at least one molded bead foam article is at least partially machined. It has been unexpectedly discovered that machining a molded bead foam article formed from PLA produces up to 50% less waste than a comparable molded bead foam article formed from expandable polystyrene, and the dust that is produced is easily compostable and biodegradable. As used herein, “machined” refers to the process of cutting, drilling, milling, die-cutting and/or shaving the molded bead foam article in order to produce smaller molded foam article(s) or to shape the molded foam article. Machining processes may involve the use of lathes, cutting tools, hot wire, hot knives, rotary tools, die-cutting punches, drilling etc. When lathe, CNC, or water-jet machining EPS-based articles, micro and macroparticles of EPS are generated in the form of dust. This dust is not only undesirable as a messy byproduct of the machining process, but EPS-based foam dust remains incapable of recycling or composting. In addition, when machining PLA-based articles in a typical milling process using a fine cutting tool rotating at 30,000 rpm, there is a 40-60% reduction in fine particles that are produced compared to EPS-based molded articles under the same machining conditions. PLA articles can be painted with any number of commercially available paints, including those with solvents such as acetone. The ability to machine the PLA articles and paint the surface of PLA articles widens the potential use-cases for PLA foam adhesion to materials.

In some embodiments, the at least one molded bead foam article is an existing molded bead foam article having an initial intended use, such as an insulative piece of PLA-based bead foam included in a product packaging to product a product. In some embodiments, the existing piece of PLA-based bead foam was originally used as thermal protection for temperature-sensitive products, as impact protection for fragile products, or a combination thereof. Rather than discarding this PLA-based bead foam article, it may be used as described herein by adhering it to another substrate, enabling the use of the PLA-based molded bead foam article in a secondary use beyond the initial intended use, reducing overall waste attributed to the original thermal or impact packaging.

The rapid adhesion process using PLA foam by heating a surface may provide a vast array of benefits in a number of different use cases. First, it is possible to adhere substrates to PLA without using tape or film to hold the PLA foam to the substrate. The need to incorporate tape or film is both resource and time intensive activity at factories. Consequently, the adhesion process provides superior protection for products such as furniture, appliances, and windows without the use of tape or stretch wrap. As a first example, the volume of foam used within packaging may be reduced by a significant amount (for example, by 30-90% or any other amount), resulting in less waste. As another example, the use of the foam in this manner may also improve the impact and vibration protection of the goods being shipped. As yet another example, the adhesion process provides the ability to produce insulated metal containers, sheds, and other similar objects. As yet another example, the adhesion process provides the ability to form insulated plastic or metal articles, such as air ducts in residential or commercial settings or in a vehicle), insulation for pipes, temporary winter protection of pipes, etc. As yet another example, the adhesion process may provide the ability for cross-media adhesion leading to signage adhesion to brick and metal buildings. The adhesion process described herein may also provide other benefits as well.

### Methods for Producing Custom Product Packaging

Methods for producing custom product packaging are also disclosed herein. In one aspect, the methods include producing custom product packaging as described above. In another aspect, the method includes adhering at least one molded bead foam article to a surface by heating the surface and pressing the at least one molded bead foam article against the surface. In some embodiments, the at least one molded bead foam article comprises a plurality of foam beads comprising polylactic acid.

In some embodiments, the at least one molded bead foam article and the surface are adhered together without using an adhesive. In some embodiments, the at least one molded bead foam article is removable from the surface. In some embodiments, heating the surface is performed using a heating element, wherein the heating element comprises a heated roller, a heated press, steam, heat transfer fluid, a hot air gun, an infrared-emitting device, a conduction heater, or an induction spot heater. In some embodiments, the surface is heated to a temperature between or including 250° F. and 450° F. In some embodiments, only a portion of surface is heated to adhere the at least one molded bead foam article to the surface. In some embodiments, a size of the portion of the surface is less than a surface area of a portion of the at least one molded bead foam article that is adhered to the surface. In some embodiments, the surface comprises at least one of: metal, engineered plastic, glass, wood, brick, stone, ceramic, and concrete. In some embodiments, the at least one molded bead foam article is pressed against the surface for less than a second. In some embodiments, heating the at least one surface of the first molded bead foam article is performed without producing flammable gas.

### EXAMPLES

The disclosure may be further understood with reference to the following non-limiting examples.

### Example 1: PLA Foam Article Attached to Various Metal Substrates

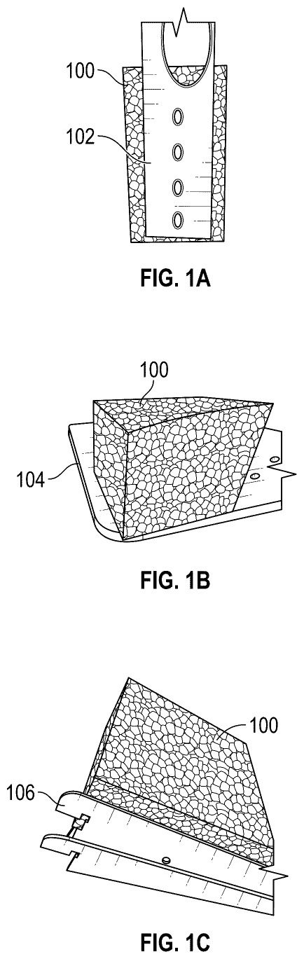

FIGS. 1A-1C show successful adhesion of the PLA foam to various metal substrates through the process of rapidly heating the metal piece and subsequent pressing the heated metal piece into the PLA foam (or pressing the PLA foam into the heated metal piece). FIG. 1A shows adhesion of the PLA foam 100 to copper 102. FIG. 1B shows adhesion of the PLA foam 100 to Aluminum 104 with a textured powder-coat. FIG. 1C shows adhesion of the PLA foam 100 to a metal 106 with an epoxy finish. Nickel (99.96%) was also successfully tested. Similar adhesion is also possible with other types of metals, such as lead and tin, for example.

In the majority of cases, no residue remained on the metal surface after removal of the foam. However, even instances in which a negligible amount of residue remains on the metal surface, the residue may be removed without the use of a cleaning product or moisture (for example, removing the residue using a paper towel).

Appliances, commercial, and industrial machines may be created at a manufacturer using foam, foam sheets, and plastic wrap, for example. These items provide some protection for the goods during storage and transportation. However, conventionally a human may need to hold the protection pieces in place as a film is wrapped around the machine. The ability to apply foam directly to sharp edges and weaker edges, and have the foam stay in one place is beneficial in eliminating or reducing breakage and damage.

Insulating metal is challenging using in-place PU, XPS, fiberglass, wool, etc. as these types of materials may not adhere perfectly to the metal. This results in air gaps and air pockets. Air gaps may lead to significant reduction in system insulation value. In contrast, the adhesion method described herein results in closer contact with a metal surface and allows for the sealing of such gaps.

Being able to adhere foam to a metal surface is also beneficial in improving safety. For example, the product may be deployed to protect human operators from sharp metal edges or moving metal arms. The product may also protect an edge from accidental impact. The low density of the foam leads to negligible added mass to the machine.

Industrial machines may include ducts that are not round in shape, which requires custom insulation fabrication. Conventional insulation may not provide an effective fit. Therefore, providing insulation to any shaped surface is beneficial. In some instances, no priming, painting, or gluing is necessary. The insulation has a limit of applicability from 70° C. to −70° C. Using thermoforming in combination with the method described herein results in this process being highly adaptable.

Insulating metal totes, drums, and tankers from hot or cold can be easy requiring no change to the chemical storage environment.

Creating a refrigerated truck, ice cream carts, insulated portable sheds, or insulated industrial steel buildings may be more cost effective using this adhesion process described herein. The material and installation cost is expected to be 80-90% lower than alternative methods due to the low density and ease of PLA foam installation.

With metal adhesion, there is always a clean-up challenge. Normal adhesives are not able to stick to metal for extended time due to challenges with thermal expansion, the existence of oils on the surface, texture, and/or coatings. PLA foam unexpectedly addresses all these challenges.

The adhesion process may also be used to provide protection for aluminum window shipping from a manufacturer to a distributor and/or to an end user.

### Example 2: Reducing Adhesion Force by Changing the Contact Area

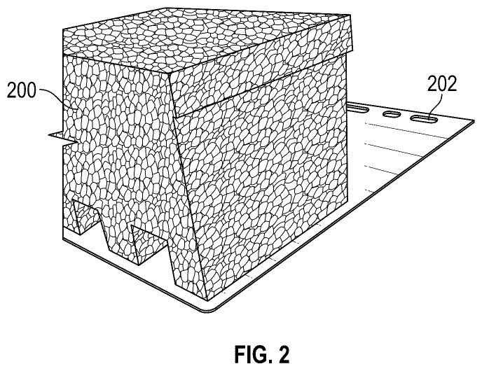

The total force of adhesion or peel strength required to remove the foam from the metal surface may be modified by changing the contact cross-section (an example is shown in FIG. 2). This may be accomplished by limiting the size of heating relative to the foam 200. For example, affixing an eight square inch foam 200 to metal 202, but heating only two square inches leads to a smaller adhered area, which consequentially results in a lower force being required to remove the foam 200 from the surface. Additionally, unique foam shapes such as ridges may be created and the foam may be adhered only at the ridge to the metal surface. Additionally, other structures are possible. The shape may lead to defined or engineered mechanical response of metal/foam combination.

### Example 3: Adhesion to Wood

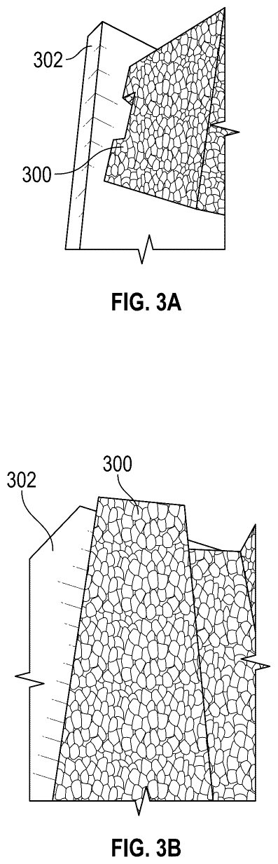

The foam may similarly be adhered to wood using the same process by which the foam may be adhered to a metal surface or any other type of surface. This process was tested with particle wood, wood laminates, wood planks, stained wood, etc. The adhesion process did not discolor or change the surface of the wood. FIGS. 3A-3B provide an example of adhesion of foam 300 to a wooden surface 302.

The method described herein uses less material to protect bookcases, tables, beds and other furniture, etc. Improved packing (as a result of the adhesion process described herein) may reduce potential product damage during storage and transportation. Improved packing may also allow for more compact placement or stacking of boxes on transportation vehicles. The improved packing may be used to more effectively insulate horse sheds, wooden buildings, wood doors, etc. Protection can be added to wood windows during transportation from a manufacturer to a distributor and/or to an end user. Protection may also be added to cabinets and thermoelectric chillers.

### Example 4: Adhesion to Glass

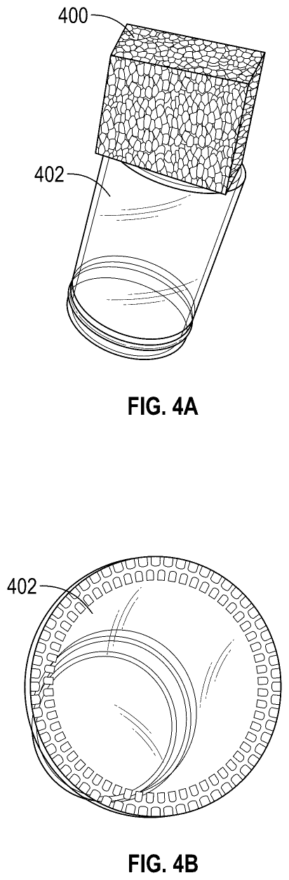

FIGS. 4A-4B show adhesion of foam 400 to glass 402, particularly a ball jar/soda lime glass (72% silica, 15% soda, 9% lime, 3% magnesium, 1% alumina, boric oxide —, manganese oxide —, potassium oxide—). Adhesion was also tested with: (i) Pyrex (4.0% boron, 54.0% oxygen, 2.8% sodium, 1.1% aluminum, 37.7% silicon, and 0.3% potassium) (ii) Luminarc (30% recycled, 50% silica, 15% soda, 5% lime/mineral), and (iii) Tile—(crystalline silica/quartz 0-30%, amorphous silica (fused) 0-80%, clays 0-60%, talc 0-40%, biotite 0-5%).

Glass is effective at preserving flavors and fragrance and accordingly has use in beverage and sauce packaging. However, glass is fragile and requires protection. Additionally, specialty-sized and custom packaging may be required for glass jars and bottles. The ability to provide glass between surrounding foam may enable anyone to package glass. The use of the foam as described herein may also reduce breakage with bulk shipments as well. Further, the use of the foam as described herein may provide for temporary insulation of windows. The ability to quickly cover up a broken window using window sides or portion of intact glass using this solution is beneficial.

### Example 5: Adhesion to Engineering Plastics

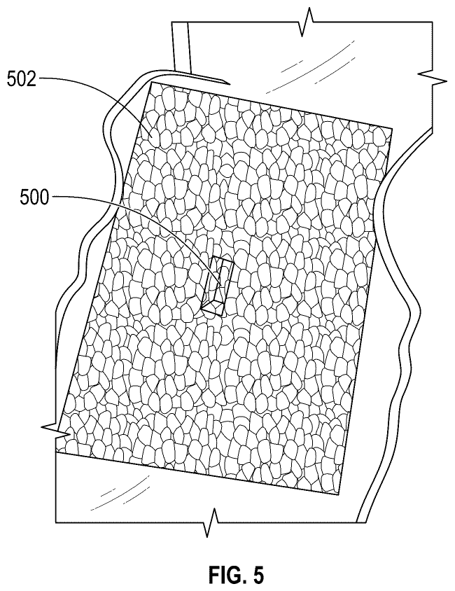

In some instances, it may be challenging to in-place foam using polyurethane given that the surface energy of most plastics influence the foaming behavior proximate to the surface. The ability to attach PLA foam to glass filled nylon, unfilled nylon, polycarbonate, glass filled PP, PP and other engineered plastics with a heat deflection temperature (HDT)>130° C. allows for an effective bond between plastic and foam. This has applications in air conditioning ducts in transportation, for example. In sub-teen temperatures, the foam may protect articles made with engineered plastics or anything stored within the plastic from reaching a critical low temperature or cracking under impact. FIG. 5 shows an example of adhesion of foam 500 to Polycarbonate 502. Testing also revealed the unexpected result of the ability to adhere PLA to Polyethylene terephthalate (PET), a polymer with a Tg below 70° C. For this study, PET was heated to only 140 F while PLA foam piece was heated to 325 F.

Adhesion to plastic provides a number of potential use cases. For example, the foam insulation may be adhered to a tote (or similar type of product), effectively converting the tote into an insulated tote. Adhering foam within a portable cooler may involve surface treatment with plasma or flame followed by in-place foaming with polyurethane. Their process produces limited-size coolers. The adhesion process as described herein allows for the production of any size thermal shipper.

### Example 6: Adhesion to Other Substrates

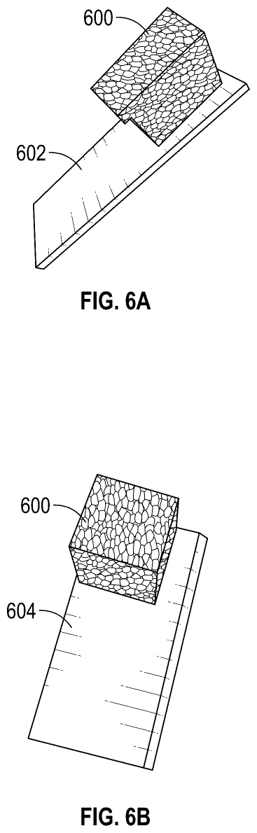

Additional testing was performed to determine that adhesion is possible with any number of different types of surfaces, such as glazed ceramic tile, smoothed marble (shown in FIG. 6A with foam 600 being adhered to marble 602), brick (shown in FIG. 6B with foam 600 being adhered to brick 604), paper, concrete, polymer clay, and/or any other types of surfaces.

All the above cases show good adhesion. Above examples show PLA foam with 1″ cube. Foam can be ⅛″ to ¼″ thick depending on insulation or impact protection need (or any other thickness).

### PLA for Protecting Stone Articles

Cracks or breakage of granite or stone countertops may often result from stress during handling, fabrication, transportation, or installation of the countertop. Marble slabs and countertops, quartz countertops, travertine, or limestone are prone to cracks. Application of PLA foam may reduce stresses at the various stages of handling. Stone is found in bathroom sinks and counters, bath surrounds, fireplaces, kitchen counters, floors, architectural walls, and furniture tops. Reducing breaks in these materials saves money and reduces the carbon footprint associated with mining and transportation. Separating or prevented scratches on surface is important for all stone flat articles. Having foam attached to the surface addresses both of these challenges.

### PLA for Concrete

Insulating basements with PLA is yet another example of a use case. PLA foam may not retain water and may retain insulation properties even when sprayed with water. With its low density and subsequently super low energy density of material, the foam may be suitable for insulating concrete structures with negligible fire fuel potential. In addition, the adhesion process may be used to easily attach posters, mirrors, dartboards to concrete walls.

### Cross-Media Adhesion

It may be difficult to adhere plastic to metal, plastic to brick, metal to concrete, and so forth. Using PLA foam, two different types of surfaces may be more easily joined together. For example, banners, signs, flags, and small pots may be adhered to bricks within seconds without damaging brick or concrete. Further, pots may be easier secured to window ledge or balconies.

Cross-media adhesion between plastic and metal is beneficial as well. Metal with high thermal expansion leads to delamination from plastic using conventional adhesives. Plastic signage may be attached to metal objects such as semi-trucks, food trucks, and buildings with negligible cost compared to vinyl wrap.

Other examples of cross-media adhesion include attaching patio furniture to the concrete patio preventing furniture from blowing away, attaching a holiday light projector to a sidewalk, attaching labels to metals, attaching lamps, power extension, pen holders to desks or side tables, attaching plastic or metal soap dispenser to mirror in public bathrooms, etc. In these applications, PLA foam adheres to both substrates. The superior compression and flex strength of the PLA foam compensates for thermal expansion and mitigates potential vibration.

ePET, ePBT, blends of PLA with other biopolyester are all suitable alternatives.

Table 1 provided below shows adhesion to various substrates along with estimated adhesion strength.

TABLE 1
Adhesion strength of various substrates to PLA foam

| | Bond | Surface | Surface | Heat |
|---|---|---|---|---|
| | Strength | Smoothness | Energy | Capacity |
| Material | (PSI) | (RMS) | (dynes/cm) | (J/g K) |
| Aluminum - (6061) | 35 | 420 | 25 | 921 |
| Textured Powdercoat | | | | |
| Aluminum Sheeting | 47 | 20 | 840 | 921 |
| (3003/3004) | | | | |
| Brick | 40 | 560 | 266 | 841 |
| Cardboard | 45 | 60 | 45 | 1330 |
| Concrete Block | 25 | 900 | 50 | 879 |
| Copper | 55 | 20 | 1103 | 377 |
| Glass - Ball Jar/Soda | 25 | 125 | 72 | 870 |
| Lime Glass | | | | |
| Glass - Luminarc | 25 | 8 | 153 | 840 |
| Glass | | | | |
| Glass - Pyrex | 30 | 1 | 153 | 753 |
| Glass - Tile | 35 | 16 | 375 | 500 |
| Glazed ceramic tile | 30 | 4 | 52 | 323 |
| Marble | 35 | 33 | 28 | 832 |
| Metal Epoxy Finish | 35 | 10 | 43 | 450 |
| Nickel | 55 | 18 | 2340 | 440 |
| Paper | 60 | 1 | 40 | 1340 |
| PET | 35 | 10 | 42 | 1030 |
| Polycarbonate - Sch | 35 | 109 | 42 | 1100 |
| 60, clear | | | | |
| Polymer Clay - | 60 | 120 | 55 | 937 |
| (PVC + phthalate | | | | |
| plasticizer) | | | | |
| Stainless Steel A303 | 50 | 20 | 900 | 502 |
| Steel - Bronze | 35 | 10 | 28 | 502 |
| powder coat | | | | |
| Teflon Coated | 25 | 300 | 18 | 700 |
| Fiberglass | | | | |
| Wood Oak, | 43 | 420 | 45 | 2380 |
| Hardwood | | | | |
| Zinc - Die Cast | 35 | 30 | 753 | 377 |

As shown in Table 1, the PLA foam can form a robust bond to a variety of substrates, requiring a force of around 20 psi or greater to remove. This is highly advantageous, particularly considering the bond is achieved through only a heat-seal without additional tape or glue.

While the disclosure has been described with reference to a number of embodiments, it will be understood by those skilled in the art that the disclosure is not limited to such embodiments. Rather, the disclosure can be modified to incorporate any number of variations, alterations, substitutions, or equivalent arrangements not described herein, but which are commensurate with the spirt and scope of the disclosure. Conditional language used herein, such as “can,” “could,” “might,” or “may,” unless specifically stated otherwise, or otherwise understood within the context as used, generally is intended to convey that certain embodiments include, while other embodiments do not include, certain features, elements or functional capabilities. Additionally, while various embodiments of the disclosure have been described, it is to be understood that aspects of the disclosure may include only some of the described embodiments. Accordingly, the disclosure it not to be seen as limited by the foregoing described, but is only limited by the scope of the appended claims.

That which is claimed is:

1. A custom product packaging comprising at least one bead foam article comprising polylactic acid, wherein the at least one molded bead foam article has been adhered to a surface by heating the surface and pressing the at least one molded bead foam article against the surface.

2. The custom product packaging of claim 1, wherein the at least one molded bead foam article and the surface are adhered together without using an adhesive.

3. The custom product packaging of claim 1, wherein the at least one molded bead foam article is removable from the surface.

4. The custom product packaging of claim 1, wherein heating the surface is performed using a heating element, wherein the heating element comprises a heated roller, a heated platen, a hot air gun, an infrared-emitting device, a conduction heater, an induction spot heater, steam, or a heated fluid.

5. The custom product packaging of claim 1, wherein the surface is heated to a temperature between or including 250° F. and 450° F.

6. The custom product packaging of claim 1, wherein only a portion of surface is heated to adhere the at least one molded bead foam article to the surface.

7. The custom product packaging of claim 6, wherein a size of the portion of the surface is less than a surface area of a portion of the at least one molded bead foam article that is adhered to the surface.

8. The custom product packaging of claim 1, wherein the surface comprises at least one of: metal, engineered plastic, glass, wood, brick, stone, ceramic, concrete, fabric, leather, and vinyl.

9. The custom product packaging of claim 1, wherein the surface comprises a substrate having a thickness of 0.1 mm or more.

10. The custom product packaging of claim 1, wherein the at least one molded bead foam article is pressed against the surface for less than 5 seconds.

11. The custom product packaging of claim 10, wherein heating the surface of the at least one molded bead foam article is performed without producing flammable gas.

12. The custom product packaging of claim 1, wherein a compressive strength is unchanged upon adhesion.

13. The custom product packaging of claim 1, wherein a thermal protection of the custom product packaging is enhanced through the adhesion process.

14. A method for producing custom product packaging comprising:
adhering at least one molded bead foam article to a surface by heating the surface and pressing the at least one molded bead foam article against the surface,
wherein the at least one molded bead foam article comprises a plurality of foam beads comprising polylactic acid.

15. The method of claim 14, wherein the at least one molded bead foam article and the surface are adhered together without using an adhesive.

16. The method of claim 14, wherein the at least one molded bead foam article is removable from the surface.

17. The method of claim 16, wherein a force to remove the at least one molded bead foam article from the surface is at least 20 psi.

18. The method of claim 16, wherein removal from the surface leaves no residue on the surface.

19. The method of claim 14, wherein heating the surface is performed using a heating element, wherein the heating element comprises a heated roller, a heated press, a hot air gun, an infrared-emitting device, a conduction heater, an induction spot heater, steam, or a heated fluid.

20. The method of claim 14, wherein the surface is heated to a temperature between or including 250° F. and 450° F.

21. The method of claim 14, wherein only a portion of surface is heated to adhere the at least one molded bead foam article to the surface.

22. The method of claim 21, wherein a size of the portion of the surface is less than a surface area of a portion of the at least one molded bead foam article that is adhered to the surface.

23. The method of claim 14, wherein the surface comprises at least one of: metal, engineered plastic, glass, wood, brick, stone, ceramic, and concrete.

24. The method of claim 14, wherein the at least one molded bead foam article is pressed against the surface for less than 5 seconds.

25. The method of claim 24, wherein heating the surface of the at least one molded bead foam article is performed without producing flammable gas.
